(19) United States
(12) Patent Application Publication
(10) Pub. No.: US 2021/0223137 A1
(43) Pub. Date: Jul. 22, 2021

(54) METHOD FOR DETERMINING RISK OF DAMAGE TO A STRUCTURE AND ASSOCIATED SYSTEM

(71) Applicant: STANEO, Toulouse (FR)

(72) Inventors: Sébastien JUDENHERC, Toulouse (FR); Farouk FRIGUI, Tarbes (FR); Olivier DALVERNY, Laloubere (FR)

(21) Appl. No.: 17/259,860

(22) PCT Filed: Jul. 15, 2019
(86) PCT No.: PCT/FR2019/051772

§ 371 Date: Jan. 12, 2021

(30) Foreign Application Priority Data
Jul. 13, 2018 (FR) 18 56501

(51) Int. Cl. G01M 5/00; G06Q 10/06

(52) U.S. Cl. CPC G01M 5/0066; G06Q 10/0635

(57) ABSTRACT

Disclosed is a method for determining a risk of damage to a structure, where the method is implemented by a system including at least one sensor suited for acquiring vibration measurements from the structure and a processing unit, and including the following steps: selecting, from a plurality of samples acquired during a set time, a selected sample representative of the state of the structure, according to a lowest energy criterion; decomposing the modulus of the Fourier transform of the selected sample into a set of functions representative of the highest amplitude frequency peaks, where each representative function has a center frequency; and detecting a risk of damage to the structure when the center frequency of one of the representative functions corresponds to one of the eigenfrequencies of the structure and has a frequency variation with a value over a preset threshold.

### FIELD OF THE INVENTION

The invention relates to the monitoring of structures such as buildings, dams, bridges or works of art, for example.

### PRIOR ART

Measuring vibrations generated within structures is known in order to monitor and issue a notice concerning the state of the structure in question.

Placing vibration sensors on structures and monitoring the amplitude of the measured vibrations in real time is known. An alarm signal is then generated when the vibrations measured on the structure are too large and could lead to damage to the structure. However, the alarm signal generated does not necessarily disclose damage.

Additionally there are other monitoring systems with which to continuously record vibrations generated within structures. Analysis of the collected data can be used to detect whether damage occurred and, in some cases, to locate the damage. To do that, the collected data must be time-stamped or synchronized. For example, such a monitoring system is installed on the Ophite high-rise at Lourdes and is part of a continuous observation network. The system comprises a plurality of accelerometers connected to a GPS receiver with which to time-stamp the measurement signals. Since the accelerometers are connected to the GPS receiver by cables, the installation of such a surveillance system is not easy. Further, such a system is relatively costly because of the presence of scientific quality accelerometers and of the GPS receiver in particular. Additionally, such systems are not suited for processing data in real time.

### BRIEF DESCRIPTION AND ADVANTAGES OF THE INVENTION

In particular, the present invention aims to remedy the aforementioned disadvantages from the prior art.

In particular, a goal of the invention is to provide a system with which to detect a risk of damage to a structure in real time.

Another goal of the invention is to provide a system that is easy to install and less costly.

Another goal of the invention is to simplify the processing of the collected data and to minimize the calculation power necessary and the quantity of data to be sent.

For that purpose, the present invention proposes, according to a first aspect, a method for determining a risk of damage to a structure, where the method is implemented by a system comprising at least one sensor suited for acquiring vibration measurements from the structure and a processing unit, and comprising the following steps:
selecting, from a plurality of samples acquired during a set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;
detecting a risk of damage to the structure when the center frequency of one of the representative functions corresponds to one of the eigenfrequencies of the structure and has a frequency variation with a value over a preset threshold, preferably for a set time.

The above steps are not necessarily done sequentially, but may be done in parallel.

It will be noted that the “lowest energy criterion” applies just as well in the time domain as in the frequency domain and serves to select from the plurality of acquired samples a sample comprising the fewest parasite signals. The energy can be calculated on the basis of an integral of a time- or frequency-domain signal from a data sample acquired by at least one vibration sensor. Typically, it involves an integral of a time or frequency-domain signal, and more specifically of a signal representative of the modulus of the Fourier transform of the sample. It can also involve a measurement of statistical variation of the time values of the sample with it understood that a sample having a minimum standard deviation also has a minimum energy.

In an embodiment, the representative functions are Gaussian functions.

In an embodiment, the step of selecting a sample representative of the state of the structure comprises, for each sample acquired during the preset time, the calculation of the modulus of the Fourier transform of each acquired sample, the integration of the signal representative of the modulus of the Fourier transform over a preset frequency band and the selection of the sample for which the integral of said signal is minimal.

In a preferred embodiment, the signal representative of the modulus of the Fourier transform of the sample is the power spectral density.

In an embodiment, the calculation of a signal representative of the modulus of the Fourier transform of the sample comprises:
calculating the Fourier transform of the sample; and
calculating the power spectral density using the modulus of the Fourier transform of the sample.

In an embodiment, the method further comprises a step of identification of the eigenfrequencies of the structure from the set of functions representative of the highest amplitude frequency peaks.

In an embodiment, the method further comprises a step of calculating the eigenfrequencies of the structure from the set of functions representative of the highest amplitude frequency peaks. In an embodiment, the method further comprises a step of sending the center frequency of each function representative of the highest amplitude frequency peaks to a remote calculation unit and the step of detecting a risk of damage to the structure is implemented by the remote calculation unit.

In an embodiment, the sensor is suited for measuring vibrations of the structure along at least one detection direction.

In an embodiment, the sensor comprises at least one geophone suited for acquiring vibration velocity measurements for the structure along a set direction.

In an embodiment, the sensor comprises at least two geophones suited for acquiring vibration velocity measurements for the structure along a first and a second direction, respectively, where the two geophones are positioned such that the first and second directions are perpendicular.

In an embodiment, the method further comprises the storage, in a remote memory, of a damage risk indicator to the structure.

In an embodiment, the method further comprises sending a damage risk indicator to a terminal of a user.

According to a second aspect, the present invention proposes a computer program product comprising, when it is implemented by a processor, at least code instructions for implementing the following steps:
selecting, from a plurality of samples acquired during a set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;

In a preferred embodiment, the computer-program product further comprises code instructions for implementing the following step:
detecting a risk of damage to the structure when the center frequency of one of the representative functions corresponds to one of the eigenfrequencies of the structure and has a frequency variation with a value over a preset threshold, preferably for a set time.

Finally, according to a third aspect, the present invention proposes a system for detecting a risk of damage to a structure comprising:
at least one sensor suited for acquiring a plurality of vibration measurement samples from the structure;
a processing unit configured for:
selecting from the plurality of samples acquired during the set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;
detecting a risk of damage to the structure when the center frequency of one of the representative functions corresponds to one of the eigenfrequencies of the structure and has a frequency variation with a value over a preset threshold, preferably for a set time.
   In an embodiment, the processing unit comprises:
a first and a second calculation unit, where the second calculation unit is a remote calculation unit;
where the first calculation unit is configured for:
selecting from the plurality of samples acquired during the set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;
sending the center frequency of each function representative of the highest amplitude frequency peaks from the set, for each selected sample;
where the second remote calculation unit is configured for:
receiving the center frequency of each function representative of the highest amplitude frequency peaks from the set, for each selected sample;
detecting a risk of damage to the structure when the center frequency of one of the representative functions corresponds to one of the eigenfrequencies of the structure and has a frequency variation with a value over a preset threshold, preferably fora set time.

The present invention has many advantages. First, the measured data do not need to be synchronized or time-stamped by a GPS signal. The data measured by the various sensors can therefore be sent using a wireless communication protocol and the sensors are therefore easier to install. Next, the data stored in memory or transmitted are minimized and the calculation time limited, in particular by selecting the least energy samples, decomposing the modulus of the Fourier transform for each selected sample into a plurality of functions representative of the highest amplitude peaks, and sending, as applicable, the parameters from these functions to a remote calculation unit. It is therefore possible to implement lower-cost systems operating in real time. The cost can also be reduced by the use of one or more geophones comprising a processing unit suited for equalizing the frequency response of the low-cost geophones used. Further, it is also possible to date the changes occurring in the structure, in particular following work, by consulting the history of the damage risk indicator. It is therefore also possible to identify the cause from it.

### BRIEF DESCRIPTION OF THE DRAWINGS

Details and advantages of the present invention will appear more clearly from the following description, made with reference to the attached drawings on which:

FIG. 1 shows a method for detecting a risk of damage according to an embodiment of the invention;

FIG. 2 shows a system for detecting a risk of damage according to an embodiment of the invention;

### DETAILED DESCRIPTION OF AN EMBODIMENT OF THE INVENTION

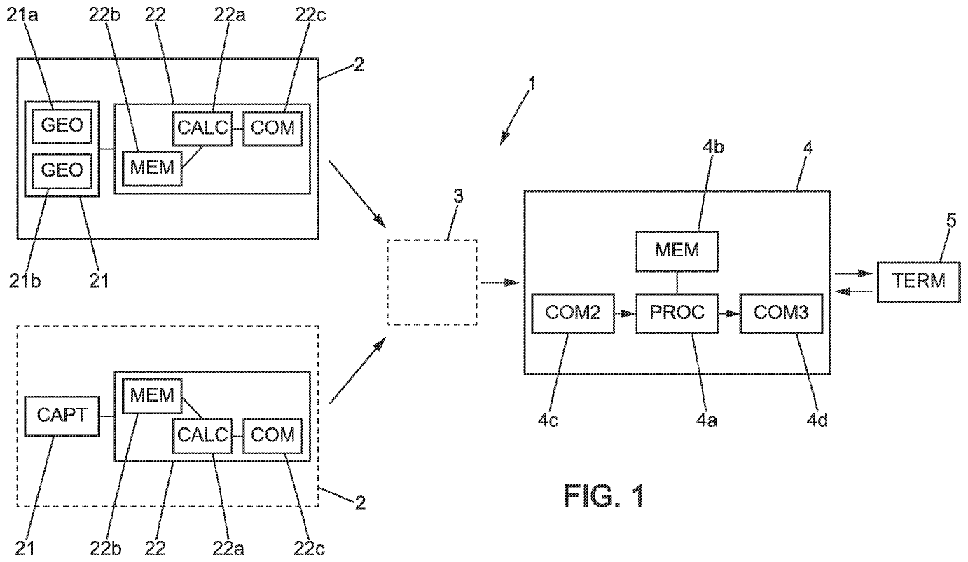

FIG. 1 shows a damage detection system according to an embodiment according to the invention.

The damage detection system 1 comprises at least one acquisition unit 2 and one remote calculation unit 4.

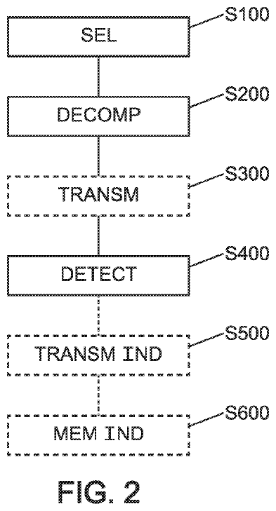

The acquisition unit 2 comprises a sensor 21 suited for detecting vibrations of the structure on which it is placed and a calculation unit 22. The calculation unit 22 is configured for selecting, from samples acquired by the sensor 21, a sample representative of the structure, decomposing said sample into a set of functions representative of the highest amplitude frequency peaks and sending the data relating to the functions representative of the highest amplitude frequency peaks to the remote calculation unit 4 via the communication interface 22c by executing the steps S100 to S300 described with reference to FIG. 2 described below. The calculation unit 22 comprises a calculator 22a, memory 22b able to store instructions to be implemented by the calculator, and a communication interface 22c. The calculator 22a may be a microcontroller, a processor or a microprocessor. The calculation unit 22 is connected to a sensor 21 and may be able to command the acquiring of vibration measurements by the sensor and to receive these vibration measurements. If necessary, the calculation unit 22 may also comprise an analog-to-digital converter, if the vibration measurements made by the sensor are analog. The analog-to-digital converter may for example be integrated into the microcontroller.

The remote calculation unit 4 comprises a calculator 4a, for example a processor, remote memory 4b comprising instructions intended to be executed by the calculator and a communication interface 4c. The communication interface 4c is able to receive data relating to the functions representative of the highest amplitude frequency peaks for each selected sample. The remote calculation unit 4 is configured in order to detect a damage risk from the data received via the communication interface 4c thereof by executing steps S400 to S600 described with reference to FIG. 2. In particular, the remote calculation unit 4 is capable of detecting a damage risk from a center frequency variation of one of the functions representative of highest frequency and updating a damage risk indicator to the structure.

Further, the remote calculation unit 4 comprises an interface 4d able to communicate with the terminal 5 of the user, such as a computer, smart phone, tablet or data server. The calculation unit 4 can periodically send the damage risk indicator to the terminal 5 of the user, via an SMS for example if the terminal is a smart phone or only send any update of the indicator. The calculation unit 4 may also allow remote access from the terminal 5 of the user, through the Internet for example, to the data stored in the memory 4b. The memory 4b may therefore also, or alternatively, comprise a history of the data collected in the state of the indicator.

In the embodiment described here, it will be noted that the system 1 comprises just one acquisition unit 2. In other embodiments, the system 1 may comprise several acquisition units similar to those previously described present on the structures. The data relating to the functions representative of the highest amplitude frequency peaks from each acquisition unit 2 can be directly sent to the remote calculation unit 4. Alternatively, these data may be collected through an intermediate module 3 configured for communicating with the acquisition units 2 according to a first protocol such as LORA® or SIGFOX®, for example, and centralizing the data from the various acquisition units, with or without preprocessing, to the remote calculation unit 4 via another protocol, for example. The intermediate module 3 therefore comprises two communication interfaces, where one is configured for communicating with the acquisition units and the other is configured for communicating with the remote processing unit, by Internet, for example.

Advantageously, the sensor 21 is suited for measuring vibrations of the structure on which it is placed along at least one direction. It may involve, for example, one or more piezoelectric sensors able to measure displacements, one or more geophones able to measure velocities or accelerometers able to measure accelerations. The sensor 21 is suited for measuring vibrations of the structure along at least one detection direction. In fact, when the direction of one of the resonant modes of the structure is known or easily determinable, it is possible to use the sensor whose detection direction is oriented along one of the resonant modes of the structure.

On the other hand, when the resonant modes are unknown or hard to identify, the sensor 21 comprises other detection directions, where the detection directions are preferably mutually perpendicular. In that way it is assured that signals representative of vibrations of the structure can be measured without drawing attention to the orientation of the resonant modes of the structure.

In a preferred embodiment, the sensor 21 comprises two geophones 21a, 21b, where each geophone is suited for acquiring the vibration speeds of the structure along a detection direction. Advantageously, the two geophones our positions such that the respective detection directions thereof are orthogonal. This configuration is particularly advantageous, because most structures considered, such as buildings and dams for example, have two axes of symmetry with which two distinct resonant modes oriented in a single plane can be associated.

The use of geophones is particularly advantageous because they are suited for measuring vibration speeds having frequencies included between 0.2 and 20 Hz, preferably included between 1 Hz and 15 Hz, for example, at lower cost. There are specifically geophones connected to processing units able to expand and equalize the spectral response of the low-cost geophones used. An example of a geophone connected to a digital processing unit is described for example in the application FR 17/059513. The processing unit of the geophone may therefore be configured for performing the steps S100 to S300 previously described.

In another embodiment, the steps done by the remote calculation unit are done directly by the acquisition unit. The system 1 then comprises only acquisition units each comprising a sensor and a processing unit implementing steps S100, S200 and S400 and optionally the steps S500 and S600.

FIG. 2 shows a method for detecting a risk of damage according to an embodiment of the invention.

The method comprises a step S100 of selecting a sample representative of the state of the structure from a plurality of samples acquired during a set time, a step S200 of decomposing the modulus of the Fourier transform of the selected sample into a set of functions representative of the highest amplitude frequency peaks, where each representative function has a center frequency, and the step S400 for detecting a risk of damage to the structure when the center frequency of one of the representative functions corresponds to one of the eigenfrequencies of the structure and varies with the value over a preset threshold, preferably during a set time.

Further, the method may optionally comprise, when it is implemented by a system comprising a remote calculation unit such as described for example with reference to FIG. 1, a step S300 of transmission to a remote calculation unit of at least the center frequency of each function representative of the highest amplitude frequency peaks.

In an embodiment, the step S100 of selecting a sample representative of the state of the structure from a plurality of samples acquired during a set time, according to a least energy criterion, comprises the following substeps:
acquiring a plurality of samples during a set time;
calculating the standard deviation for each sample over the set of measurement points present in the sample; and
selecting the sample having the minimum standard deviation.

In another embodiment, the step S100 of selecting a sample representative of the state of the structure from a plurality of samples acquired during a set time, according to a least energy criterion, comprises the following substeps:
acquiring a plurality of samples during a set time;
calculation, for each sample, of the modulus of the Fourier transform, and of the spectral power density, where the spectral power density is defined as the ratio of the modulus of the Fourier transform squared over the acquisition time of the sample;
integration, for each sample, of the power spectral density over the frequency band considered for determining the global power spectral density;
selecting the sample with the global minimum spectral power density.

The step of selecting the sample with the least energy serves to select the sample having the least parasitic vibrations, i.e. unstable, during the time covered by the selection. The selected sample having the least energy is therefore the most representative of the state of the structure for the time considered. The sample in fact comprises vibrations corresponding to vibration modes of the structure and to other vibrations due, for example, to the start-up of a pump on a dam. If this pump is actuated periodically over a set time, it is possible to select a sample not having vibrations related to the operation of the pump, by choosing the sample having the least energy from the samples measured over a time longer than the time of actuation of the pump. This selection step serves to filter temporary parasitic vibrations over the time considered. The method based on the calculation of the modulus of the Fourier transform is more effective because it considers the various frequency components of the sample and serves to select the sample which has the least parasitic vibrations during the time considered during the selection step S100. Selecting a selected sample having the least energy, meaning whose energy is less than that of the other samples considered during the set time serves to limit the quantity of data to be processed and transmitted. Next, the modulus of the Fourier transform of the selected sample is decomposed into a set of functions representative of the highest amplitude frequency peaks during step S200.

The step S200 comprises:
A substep of detecting of the highest amplitude peak from the modulus of the current Fourier transform of the selected sample;
A substep of determining the function representative of the highest amplitude frequency peak, where the representative function is a statistical distribution function like a Gaussian function, for example;
A substep of storage in memory of at least the center frequency of the corresponding representative function. Other representative parameters of the representative function such as the width and amplitude of the Gaussian, for example, can also be stored;
A substep of subtraction of the representative function from the modulus of the current Fourier transform and updating the modulus of the current Fourier transform.

These steps are reiterated a preset number of times until getting a preset number of functions representative of the highest amplitude frequency peaks.

Further, when the step S100 of selection is done on the basis of the standard deviation of the time-domain sample, the step S200 of decomposition may comprise a preliminary substep during which the Fourier transform of the selected sample is calculated.

When the step S100 of selection is done on the basis of the modulus of the Fourier transform, the modulus of the Fourier transform of the selected sample corresponds, during the first iteration, to that calculated during the step S100.

In an embodiment, when the method is implemented by a system comprising a remote calculation unit, the method comprises a step S300 of transmitting at least the center frequency of each function representative of the highest amplitude frequency peaks to a remote calculation unit. For some samples, other parameters of the representative function may be sent. It is then possible to reconstruct the various time-domain measurement points of the sample from these parameters and to calculate the eigenfrequencies of the resonant modes of the structure such as described below. The transmission of the center frequency of each representative function and possibly the transmission of other parameters of the representative function serves to limit the quantity of data sent to the remote calculation unit.

Finally, the step S400 of detecting of a risk of damage to the structure when the center frequency of one of the representative functions corresponds to one of the eigenfrequencies of the structure and varies with a value over a preset threshold, preferably for a set time comprises, in one embodiment:
selecting a frequency band chosen such that only frequency peaks corresponding to resonant modes of the structure are present in said frequency band;
calculating the absolute value of the difference between an initial center frequency and the current center frequency for at least one of the representative functions present in the selected frequency band;
detecting a risk of damage when said absolute value is greater than a preset threshold for at least one of the representative functions.

In another embodiment, selecting a frequency band chosen such that only frequency peaks corresponding to resonant modes of the structure are present in said frequency band nay be done starting at step S200 of decomposition in order to only decompose a portion of the modulus of the Fourier transform comprising eigenfrequencies and free of parasitic peaks. The step S400 then comprises:
calculating the absolute value of the difference between an initial center frequency and the current center frequency for at least one of the representative functions determined during step S200;
detecting a risk of damage when said absolute value is greater than a preset threshold for at least one of the representative functions.

Advantageously, the preset threshold is fixed such that climatic variations on the variation of the eigenfrequency are not considered. The preset threshold is therefore chosen so as to be larger than the eigenfrequency vibrations induced by climatic variations. In fact, climatic variations induce a variation of the humidity level in the concrete and because of that have an influence on the eigenfrequency of the resonant modes of the structure. A different threshold may be used according to the resonant mode and therefore the resonant frequency considered.

According to a variant, the step S400 of detecting a risk of damage for the structure comprises detecting a risk of damage when said absolute value is greater than a preset threshold for at least one of the representative functions during a set time. In that way not only are variations of the center frequency due to exceptional events avoided but also transients such as a storm are considered. The fixed time may be for example from 3 to 4 days since storms rarely last longer.

In an embodiment, the substep of selecting a frequency band comprises the calculation of the eigenfrequencies of the resonant modes of the structure.

In an embodiment, the eigenfrequencies of resonance are for example calculated from a time-domain sample acquired by the sensor by means of the stochastic method by subset called SSI-COV, described for example in the following document: “An algorithm for damage detection and localization using output-only response for civil engineering structures subjected to seismic excitations,” F. Frigui, J.-P. Faye, C. Martin, O. Dalverny, F. Peres, S. Judenherc, Proceedings of the 7th International Conference on Mechanics and Materials in Design, Albufeira/Portugal 11-15 Jun. 2017. Other methods known to the person skilled in the art can also be used.

In a preferred embodiment, surprisingly, the time-domain sample reconstituted using the parameters from the representative functions is used for calculating the eigenfrequencies of resonance. Then, the parameters sent to the remote calculation unit during the step S300 comprising the center frequencies and optionally the amplitudes of the functions representative of largest amplitude calculated during step S200 are used. When the sample is decomposed into a sufficient number of representative functions, the reconstituted sample is sufficiently pertinent. The inventors have shown that a decomposition into 16 representative functions was sufficient. The reconstituted time-domain sample is however different from the one measured because it is reconstituted solely using the modulus of the Fourier transform. The phase of the Fourier transform is not used. It is thus possible to reduce the calculation time and storage space needed in the system implementing the method. The time-domain samples are in fact only stored in memory during the calculation of the modulus of the Fourier transform. Less costly components can therefore be used.

In an alternative embodiment, the step S400 comprises:
identifying at least one center frequency corresponding to an eigenfrequency of resonance of the structure;
tracking the variation of at least one eigenfrequency identified for example by the calculation of the absolute value with the difference between an initial frequency and the corresponding current frequency;
detecting a risk of damage when said absolute value is greater than a preset threshold for at least one of the identified eigenfrequencies.

The identification of the center frequencies corresponding to eigenfrequencies of the structure is obtained by an operational modal analysis step based on a time-domain sample reconstituted using the SSI-COV method previously described and then by the study of a stability diagram such as described for example in sections 2.1 or 2.2 of the document “Stabilization diagrams to distinguish physical modes and spurious modes for structural parameter identification,” Wu, C., Liu, H., Qin, X. & Wang, J., Journal of Vibroengineering, Vol. 19, Issue 4, 2017, pages 2777-2794. This method is particularly effective for distinguishing the eigenfrequencies from the parasitic frequencies such as the frequencies of vibrations related to the use of a pump, air conditioner or other electrical frequencies such as harmonics of the 50 Hz branch circuit supply or “idle-tones” of sigma-delta technology power converters or parasitic frequencies appearing during the conversion of analog signals to digital signals. Optionally, the method further comprises a step S500 of sending an indicator of the risk of damage to a terminal of a user. This indicator may for example be sent by SMS to a mobile phone of the user.

Optionally, the method further comprises the step S600 of storage, in a remote memory, of an indicator of the risk of damage to the structure and the history of the data collected for the selected samples. Since this remote memory is remotely accessible, the user may consult the history of the risk of damage to the structure, for example.

Advantageously, the method described above is implemented by at least one acquisition unit of the system comprising a sensor and for each detection direction measured by the sensor. According to an embodiment, it is sufficient to detect a variation of the center frequency of one of the representative functions corresponding to one of the eigenfrequencies of the structure greater than a predetermined threshold in a detection direction.

1. A method for determining a risk of damage to a structure, where the method is implemented by a system comprising at least one sensor suited for acquiring vibration measurements from the structure and a processing unit, and comprising the following steps:
selecting (S100), from a plurality of samples acquired during a set time, a selected sample representative of the state of the structure, according to a lowest energy criterion, where the selected sample has a lower energy than that of the other samples from the plurality of samples;
calculating the modulus of the Fourier transform of the selected sample;
decomposing (S200) the modulus of the Fourier transform of the selected sample into a set of functions representative of the highest amplitude frequency peaks, where each representative function has a center frequency;
detecting (S400) a risk of damage to the structure when the center frequency of one of the representative functions corresponds to one of the eigenfrequencies of the structure and has a frequency variation with a value over a preset threshold.

2. The method according to claim 1, wherein the representative functions are Gaussian functions.

3. The method according to claim 1, wherein the step of selecting a sample representative of the state of the structure comprises, for each sample acquired during the preset time, the calculation of the modulus of the Fourier transform of each acquired sample, the integration of the signal representative of the modulus of the Fourier transform over a preset frequency band and the selection of the sample for which the integral of said signal is minimal.

4. The method according to claim 1, wherein the method further comprises a step of calculating the eigenfrequencies of the structure from the set of functions representative of the highest amplitude frequency peaks.

5. The method according to claim 1, wherein the method further comprises a step of sending (S300) the center frequency of each function representative of the highest amplitude frequency peaks to a remote calculation unit and the step of detecting a risk of damage to the structure is implemented by the remote calculation unit.

6. The method according to claim 1, wherein the sensor comprises at least two geophones suited for acquiring vibration velocity measurements for the structure along a first and a second direction, respectively, where the two geophones are positioned such that the first and second directions are perpendicular.

7. A non-transitory computer-readable medium on which is stored a computer program comprising, when implemented by a processor, at least code instructions for implementing the following steps:
selecting, from a plurality of samples acquired during a set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency.

8. The non-transitory computer-readable medium of claim 7, further comprising code instructions for implementing the following step:
detecting a risk of damage to the structure when the center frequency of one of the representative functions corresponds to one of the eigenfrequencies of the structure and has a frequency variation with a value over a preset threshold, preferably for a set time.

9. A system for detecting a risk of damage to a structure (1) comprising:
at least one sensor (21) suited for acquiring a plurality of vibration measurement samples from the structure;
a processing unit (22, 3, 4) configured for
selecting from the plurality of samples acquired during the set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;
detecting a risk of damage to the structure when the center frequency of one of the representative functions corresponds to one of the eigenfrequencies of the structure and has a frequency variation with a value over a preset threshold.

10. The system according to claim 9, wherein the processing unit (22, 3, 4) comprises:
a first (22) and a second calculation unit (4), where the second calculation unit (4) is a remote calculation unit;
where the first calculation unit (22) is configured for:
selecting from the plurality of samples acquired during the set time, a selected sample representative of the state of the structure, according to a lowest energy criterion, where the selected sample has a lower energy than that of the other samples from the plurality of samples;
calculating the modulus of the Fourier transform of the selected sample;
decomposing the modulus of the Fourier transform of the selected sample into a set of functions representative of the highest amplitude frequency peaks, where each representative function has a center frequency;
sending the center frequency of each function representative of the highest amplitude frequency peaks from the set, for each selected sample;
where the second remote calculation unit (4) is configured for
receiving the center frequency of each function representative of the highest amplitude frequency peaks from the set, for each selected sample;
detecting a risk of damage to the structure when the center frequency of one of the representative functions corresponds to one of the eigenfrequencies of the structure and has a frequency variation with a value over a preset threshold.

11. The method of claim 1, wherein the detecting step detects that the center frequency of one of the representative functions has a frequency variation with a value over a preset threshold for a set time.

12. The method according to claim 2, wherein the step of selecting a sample representative of the state of the structure comprises, for each sample acquired during the preset time, the calculation of the modulus of the Fourier transform of each acquired sample, the integration of the signal representative of the modulus of the Fourier transform over a preset frequency band and the selection of the sample for which the integral of said signal is minimal.

13. The method according to claim 2, wherein the method further comprises a step of calculating the eigenfrequencies of the structure from the set of functions representative of the highest amplitude frequency peaks.

14. The method according to claim 3, wherein the method further comprises a step of calculating the eigenfrequencies of the structure from the set of functions representative of the highest amplitude frequency peaks.

15. The method according to claim 2, wherein the method further comprises a step of sending (S300) the center frequency of each function representative of the highest amplitude frequency peaks to a remote calculation unit and the step of detecting a risk of damage to the structure is implemented by the remote calculation unit.

16. The method according to claim 3, wherein the method further comprises a step of sending (S300) the center frequency of each function representative of the highest amplitude frequency peaks to a remote calculation unit and the step of detecting a risk of damage to the structure is implemented by the remote calculation unit.

17. The method according to claim 4, wherein the method further comprises a step of sending (S300) the center frequency of each function representative of the highest amplitude frequency peaks to a remote calculation unit and the step of detecting a risk of damage to the structure is implemented by the remote calculation unit.

18. The method according to claim 2, wherein the sensor comprises at least two geophones suited for acquiring vibration velocity measurements for the structure along a first and a second direction, respectively, where the two geophones are positioned such that the first and second directions are perpendicular.

19. The method according to claim 3, wherein the sensor comprises at least two geophones suited for acquiring vibration velocity measurements for the structure along a first and a second direction, respectively, where the two geophones are positioned such that the first and second directions are perpendicular.

20. The method according to claim 4, wherein the sensor comprises at least two geophones suited for acquiring vibration velocity measurements for the structure along a first and a second direction, respectively, where the two geophones are positioned such that the first and second directions are perpendicular.
